(19) United States
(12) Patent Application Publication
(10) Pub. No.: US 2008/0292822 A1
(43) Pub. Date: Nov. 27, 2008

(54) THIN-WALLED COMPOSITE SLEEVE

(76) Inventors: William K. Goss, Arden, NC (US); William Haddock, Candler, NC (US); Mark Queen, Fletcher, NC (US); Melvin Douglas Pinkston, Hendersonville, NC (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 12/124,532

(22) Filed: May 21, 2008

Related U.S. Application Data
(60) Provisional application No. 60/939,159, filed on May 21, 2007.

(51) Int. Cl. B32B 1/08; B29C 53/60

(52) U.S. Cl. 428/36.1; 156/143

(57) ABSTRACT

An expandable, hollow, cylindrical thin-walled composite sleeve for use in flexographic printing applications is provided including an optional polymeric resin base layer, at least one filament wound layer over the base layer, and at least one outer non-woven fibrous layer over the filament wound layer. The filament wound layer may comprise filament wound fibers such as fiberglass which are wound around the base layer or sleeve. The non-woven fibrous layer may be in the form of a fiberglass chopped strand mat. The layers provide desirable surface and reinforcement properties to the sleeve.

### CROSS-REFERENCE TO RELATED APPLICATIONS

This application claims the benefit of U.S. Provisional Application No. 60/939,159, filed May 21, 2007, entitled THIN-WALLED COMPOSITE SLEEVE. The entire contents of said application are hereby incorporated by reference.

### BACKGROUND OF THE INVENTION

The present invention is directed to a thin-walled composite sleeve for use in flexographic printing applications, and in particular, to a hollow cylindrical composite sleeve including at least one layer of filament wound fibrous material and at least one layer of non-woven fibrous material, which layers provide desirable surface and reinforcement properties to the sleeve.

In flexographic printing operations, flexible printing plates are typically mounted onto print cylinders by wrapping and adhering the plates to an underlying hollow cylindrical sleeve. Conventional hollow cylindrical sleeves are known which have a base layer of fabric. However, such sleeves have been limited in use due to their lack of holding strength on a print cylinder as well as their lack of air-tightness required for proper mounting of the sleeve. Sleeves currently in use are typically mounted on a printing cylinder by supplying pressurized air between the sleeve and the cylinder such that the diameter of the sleeve is expanded. Accordingly, the sleeve must be sufficiently thin, typically less than about 2 mm in thickness, so as to allow the sleeve to be mounted and/or removed from the printing cylinder in this manner. In order to provide a sleeve which is thin but which provides sufficient strength and rigidity for the mounting of printing plates, many sleeves in use are comprised of one or more layers of wound filaments, such as fiberglass filaments which are coated with a polymeric resin. Such sleeves are desirable for use as they are relatively inexpensive to manufacture and have sufficiently thin wall thickness and rigidity for the desired mounting.

However, a disadvantage in the use of sleeves comprised solely of resin-reinforced wound fibers is that the flexographic printing plate is typically mounted to the outer surface of the sleeve with two-sided adhesive tape. After the printing job is completed, in order to re-use the sleeve, the plate and the tape must be removed, often with the use of a razor blade or other sharp instrument. When the tape is removed, damage to the outer surface of the sleeve can occur as fibers may be cut and removed and separated from the sleeve along with the tape. This surface damage can render the sleeve unusable for additional print jobs. In addition, sleeves comprised solely of resin-reinforced filament wound layers are subject to surface cracking as a result of the handling of the sleeves during mounting and dismounting as well as during the removal of the tape and printing plates.

Accordingly, there is still a need in the art for a thin-walled hollow cylindrical sleeve construction utilizing a filament wound material which is inexpensive to produce, which has the capability of being mounted onto a cylinder using pressurized air, and which does not possess the drawbacks of prior sleeves.

### SUMMARY OF THE INVENTION

Embodiments of the present invention meet those needs by providing a thin-walled composite sleeve comprised of at least one filament wound layer and at least one layer of non-woven fibrous material. The non-woven material is positioned on the outer surface of the sleeve to provide better surface quality and structural reinforcement to the sleeve. Such a construction eliminates the problem in filament wound sleeves of fiber separation from the sleeve and/or cracking during mounting and handling of the sleeve. The sleeve may be used in flexographic printing applications as a support for printing plates. The hollow cylindrical sleeve is low in cost to manufacture and exhibits good structural reinforcement properties.

According to one aspect of the present invention, an expandable, hollow cylindrical thin-walled composite sleeve is provided comprising an optional polymeric resin base layer and including at least one filament wound layer over the base layer and at least one non-woven fibrous layer over the filament wound layer, where the non-woven fibrous layer forms the outermost layer on the sleeve. As used herein, the term “over” refers to a layer or structure formed above or in contact with the uppermost surface of another layer or structure.

By “filament wound,” it is meant that the layer comprises a wound filament or bundle of filaments (roving) which is in continuous form. The filament wound layer preferably comprises filament wound fibers selected from fiberglass, aramid fibers, carbon fibers, polyester fibers, polypropylene fibers, and blends thereof. The filament wound fibers are preferably impregnated with a polymeric resin selected from unsaturated polyester resins, phenolic resins, epoxy resins, and polyurethane resins, to provide a fiber and resin composite matrix layer. By “impregnated,” it is meant that the resin coats the fibers and is impregnated in the spaces between the fibers in the layer.

The non-woven fibrous layer is comprised of chopped or continuous fibers adhered together by an adhesive or polymeric binder. The fibers are preferably selected from fiberglass, aramid fibers, carbon fibers, polyester fibers, polypropylene fibers, and blends thereof. In one embodiment, the non-woven fibrous layer is in the form of a fiberglass chopped strand mat. The non-woven fibrous layer may also be impregnated with a polymeric resin, to provide a fiber and resin composite matrix layer.

The composite sleeve preferably has a total wall thickness of about 0.30 mm to about 2.0 mm. In one embodiment, approximately one-half of the sleeve wall thickness comprises the filament wound layer and approximately one-half of the thickness comprises the non-woven layer.

In another embodiment of the invention, the composite sleeve further includes an inner layer of non-woven fibrous material between the filament wound layer and the optional base resin layer. In this embodiment, each of the inner layer of non-woven fibrous material, filament wound fiber layer, and outer non-woven fibrous layer comprise approximately ⅓ of the total wall thickness of the sleeve.

In accordance with another aspect of the present invention, a method of making a thin-walled composite sleeve in a single pass is provided comprising providing a hollow cylindrical support, optionally applying a base layer of polymeric resin to the support, winding at least one layer of a filament material around the base layer or support to form a filament wound layer, applying a layer of non-woven fibrous material over the filament wound layer to form an outer layer on the sleeve, and curing the sleeve. The cured sleeve is then removed from the support.

Preferably, the method includes impregnating the filament material with polymeric resin prior to winding the filament material around the base layer or support. Preferably, the method also includes impregnating the nonwoven fibrous material with polymeric resin prior to application over the filament wound layer.

In one embodiment, the filament wound material is wound at an angle of 80° to 90° from the centerline of the support. In another embodiment, the filament wound material is wound at an angle of 30° to 60° from the centerline of the support. In yet another embodiment, a portion of the filament material is wound at an angle of 80° to 90° from the centerline of the support and another portion is wound at an angle of 30° to 60° from the centerline of the support. The filament wound layer may comprise two or more wound filament layers which have been applied to the support in succession.

The method may further include applying an inner layer of non-woven fibrous material over the base layer or support prior to applying the layer of filament wound fibrous material and outer layer of non-woven fibrous material. Preferably, the method also includes impregnating the non-woven fibrous material with polymeric resin prior to application.

The composite sleeve is expandable under the application of air pressure and provides a tight seal when mounted onto a printing cylinder. The sleeve may be designed to be mounted onto a print cylinder, a mandrel, or a bridge mandrel, depending upon the desired use. The sleeve may be used as a support for the application of printing plates, for example, in flexographic printing applications. The thin wall thickness of the sleeve allows the sleeve to be easily mounted onto or removed from a printing cylinder or the like by the use of pressurized air.

Accordingly, it is a feature of the present invention to provide a reinforced thin-walled composite sleeve for use in flexographic printing operations having a low manufacturing cost and exhibiting good surface quality and reinforcement properties. These, and other features and advantages of the present invention, will become apparent from the following detailed description, the accompanying drawings, and the appended claims.

### BRIEF DESCRIPTION OF THE DRAWINGS

FIG. 1 illustrates a view in cross section of one embodiment of the hollow cylindrical sleeve of the present invention;

FIG. 2 illustrates a view in cross section of another embodiment of the hollow cylindrical sleeve of the present invention; and

FIG. 3 illustrates a partial longitudinal sectional view of a printing cylinder supporting one embodiment of the hollow cylindrical sleeve of the present invention.

### DETAILED DESCRIPTION OF PREFERRED EMBODIMENTS

Embodiments of the composite sleeve of the present invention provide several advantages over prior art sleeves comprised solely of filament wound fibers. The inclusion of a filament wound layer provides high modulus and grip strength to the sleeve, while the use of non-woven layer(s) provides a more uniform appearance to the sleeve and a more desirable texture for the outer surface, which in turn improves the overall quality of the final sleeve. Inclusion of the non-woven layer(s) also eliminates the problems of cracking or fiber tearing or separation when the sleeve is handled during mounting and dismounting onto a cylinder or during removal of printing plates.

The composite sleeve construction also provides an advantage in that the sleeve can be manufactured in a single pass, i.e., the filament wound layer may be applied immediately followed by the application of non-woven layer(s) and curing. Thus, manufacturing time is reduced, and the need for complex manufacturing equipment is eliminated.

While the composite sleeve is described herein with regard to flexographic printing applications, it should be appreciated that the sleeve may also be used in offset and gravure printing applications.

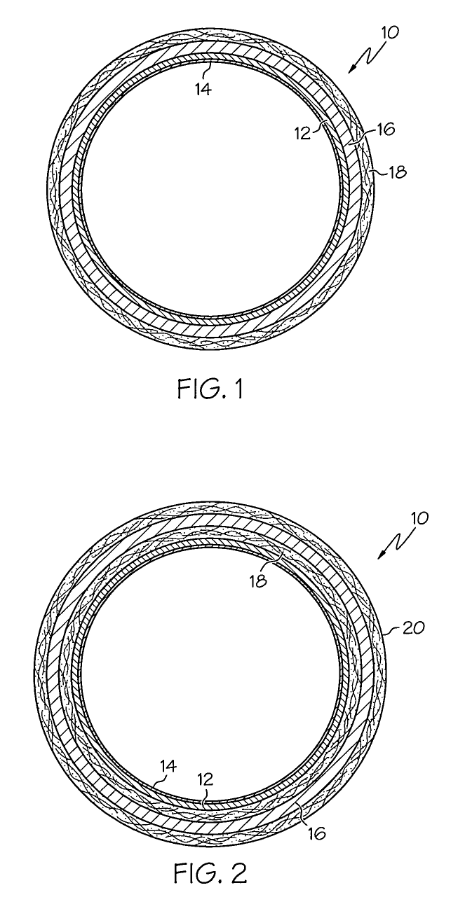

One embodiment of the reinforced, thin-walled composite sleeve 10 is illustrated in FIG. 1. In this embodiment, a thin base layer of polymer resin 12 may optionally be provided on a hollow cylindrical support 14. The cylindrical support may be comprised of metal or other polished surface. The base layer is generally about 0.02 mm to about 0.10 mm in thickness. A preferred polymer resin comprises a polyurethane or polyester and may be applied to the support by spreading uncured resin onto the support as the support is rotated. The polymer resin 12 functions to provide an inner surface for the sleeve which forms an air-tight seal when mounted onto a printing cylinder.

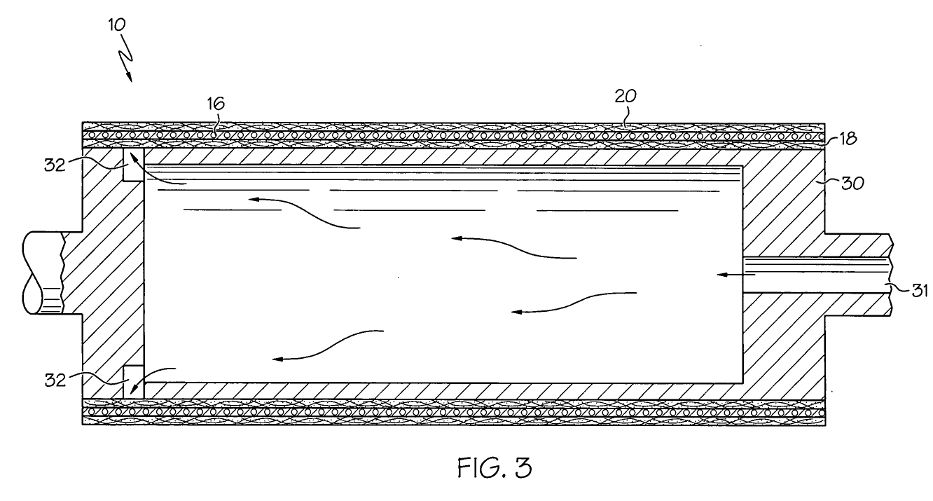

In embodiments where a polymeric base layer is not included, the innermost layer in the sleeve structure is preferably a woven layer which is sufficiently impregnated with polymeric resin so that an air-tight seal is formed without the base layer. Alternatively, the structure may comprise a sandwich structure (as shown in FIG. 3) where the non-woven layer is the innermost layer. In such embodiments, the woven and/or non-woven layers are applied directly to the support.

Referring again to FIG. 1, a layer 16 of filament wound fibers is provided over the polymeric resin layer 12. Preferably, the filament wound fibers comprise fiberglass. Other suitable fibers for use include aramid and carbon fibers, polyester, polypropylene, and co-mingled blends of these fibers. Fibers having the desired diameters and lengths are commercially available. The fibrous material may comprise a single continuous fiber or a group of fibers formed into a strand or roving.

The fibrous material is preferably applied to the cylindrical support by rotating the support while feeding a filament under tension. For example, uncured polymer resin may be coated onto the support and the fibrous material wound or wrapped about the polymer resin. Alternatively, the filament or fibrous strand (or roving) may be coated/impregnated with uncured polymer resin and applied to the support. Preferred polymer resins for use with the wound fiberglass filaments include unsaturated polyester resins, phenolic resins, epoxy resins, and polyurethane resins.

The application of fibrous material and resin may be repeated as desired to build up a sufficient wall thickness for the sleeve. Preferably, two layers of fiberglass rovings are wound onto the support in succession to form the filament wound layer 16.

The fiberglass rovings are preferably wound at two different angles. One of the angles (generally 80° to 90° from the mandrel centerline or axis) is such that the fibers are laid essentially side by side around the circumference of the sleeve to provide hoop strength and stiffness. The second angle (generally 30° to 60° from the mandrel centerline or axis) is such that the fibers are oriented more along the axial direction to provide axial and torsional strength and stiffness. In some cases, particularly for thin walled sleeves (less than 0.5 mm in thickness), the low angle (30° to 60°) filament wound layer(s) can be replaced by the non-woven layers such that axial reinforcement of the sleeve is provided by the fibers of the non-woven layer alone. In this case, the inner layer(s) are comprised of the high angle filament wound layers for circumferential reinforcement, and the outer layer(s) are comprised of the non-woven material.

The deposit speeds of the fibrous material and the tension applied to the fibers are both adjustable within broad ranges as is known in this art. The fibrous material is applied until reaching a predetermined wall thickness. A preferred wall thickness for filament wound layer 16 is from about 0.15 mm to about 1.00 mm.

Also as shown in FIG. 1, non-woven layer 18 is applied over the filament wound layer 16. The non-woven layer is preferably provided in the form of a mat of fiber-reinforced plastic material. The non-woven layer may be formed, for example, by mixing chopped glass fibers in a polymer resin. Alternatively, the non-woven layer may be comprised of continuous fibers such as spunlaid fibers. Preferred fibers for use in the non-woven layer are glass fibers. Other suitable fibers include aramid and carbon fibers, polyester, polypropylene, and co-mingled blends of these fibers. The composition and construction of the non-woven layer may be varied as desired to provide a desired ratio of machine direction versus transverse direction properties. For example, the fibers in the non-woven material may be randomly oriented to achieve essentially the same properties in all directions or more or less oriented in a particular direction to achieve different physical properties in the circumferential and axial (90° from circumferential) directions. Thus, the sleeve may be constructed to have anisotropic properties, especially through the cross-section of the sleeve wall.

The non-woven layer may be applied as a single ply or several layers may be applied to result in a multi-ply construction which achieves the desired physical properties and dimensions. The non-woven layers may be applied from a roll of narrow fabric (about 50 to 100 mm in width) by spiral winding or wrapping around the support (mandrel) in wet form (i.e., coated with an uncured polymeric resin) using an overlap. The overlap allows multi-ply construction and minimizes weakness that would otherwise be inherent at the spiral joints of a non-overlapped construction.

Referring now to FIG. 2, an alternative embodiment of the invention is illustrated in which the filament wound layer 16 is sandwiched between inner and outer non-woven layers 18 and 20. In embodiments where two non-woven layers are used, it should be appreciated that layers having different numbers of plies may be used. For example, inner non-woven layer 18 may comprise a 2-ply material while outer non-woven layer 20 may comprise a 4-ply material. The non-woven layers generally have a thickness of about 0.3 mm to about 1.0 mm.

After application of the desired filament wound and non-woven layers, the entire sleeve 10 is cured, using one of a variety of cure methods known in the art. The sleeve 10 may then be removed from the support for use. Generally, the total wall thickness for sleeve 10 is from about 0.30 mm to about 2.0 mm.

The resulting sleeve serves as a support for the application of flexographic printing plates which are made of a flexible polymeric material having a relief image. As is conventional, the printing plates may be secured to the surface of the sleeve using double-sided adhesive tape.

As illustrated in FIG. 3, the print sleeve 10 may be mounted on a print cylinder 30. Print cylinder 30 may be of any conventional construction. In the embodiment illustrated, cylinder 30 is provided with an air inlet 31 which supplies air under pressure into the interior of the cylinder from a source (not shown). A plurality of air passageways 32 provide a path to the exterior surface of print cylinder 30. Pressurized air flows through passageways 32 and acts to expand sleeve 10 slightly, enough to permit sleeve 10 to slide easily along the length of cylinder 30 until it is completely mounted. Once the air pressure is removed, sleeve 10 contracts to form an air tight seal with print cylinder 30.

Applying pressurized air again permits sleeve 10 to be expanded and completely removed from cylinder 30. It should be appreciated that the sleeve 10 may also be mounted onto a bridge mandrel which is in turn mounted onto a print cylinder.

We have found that flexographic printing plates, and the accompanying adhesive tape used to mount them, may be readily removed from the sleeve surface without damaging the sleeve. The sleeve resists surface damage and cracking.

Having described the invention in detail and by reference to preferred embodiments thereof, it will be apparent that modifications and variations are possible without departing from the scope of the invention.

What is claimed is:

1. An expandable hollow cylindrical thin-walled composite sleeve comprising an optional polymeric resin base layer and further including at least one filament wound layer over said base layer and at least one non-woven fibrous layer over said filament wound layer, said non-woven fibrous layer forming the outermost layer on said sleeve.

2. The composite sleeve of claim 1 wherein said non-woven fibrous layer comprises chopped or continuous fibers adhered together by a polymeric binder.

3. The composite sleeve of claim 2 wherein said fibers are selected from fiberglass, aramid fibers, carbon fibers, polyester fibers, polypropylene fibers, and blends thereof.

4. The composite sleeve of claim 1 wherein said non-woven fibrous layer is in the form of a fiberglass chopped strand mat.

5. The composite sleeve of claim 1 wherein said non-woven fibrous layer is impregnated with a polymeric resin.

6. The composite sleeve of claim 5 wherein said polymeric resin is selected from unsaturated polyester resins, phenolic resins, epoxy resins, and polyurethane resins.

7. The composite sleeve of claim 1 wherein said filament wound layer comprises filament wound fibers selected from fiberglass, aramid fibers, carbon fibers, polyester fibers, polypropylene fibers, and blends thereof.

8. The composite sleeve of claim 7 wherein said filament wound fibers are impregnated with a polymeric resin.

9. The composite sleeve of claim 8 wherein said polymeric resin is selected from unsaturated polyester resins, phenolic resins, epoxy resins, and polyurethane resins.

10. The composite sleeve of claim 1 having a total wall thickness of from about 0.30 mm to about 2.0 mm.

11. The composite sleeve of claim 10 wherein about one-half of the sleeve wall thickness comprises said filament wound layer and about one-half of the thickness comprises said outer non-woven fibrous layer.

12. The composite sleeve of claim 1 further including an inner layer of non-woven fibrous material between said filament wound layer and said base layer.

13. The composite sleeve of claim 12 wherein each of said inner layer of non-woven fibrous material, filament wound fiber layer, and outer non-woven fibrous layer comprise about ⅓ of the total thickness of said sleeve.

14. A method of making a thin-walled composite sleeve in a single pass comprising:
providing a hollow cylindrical support;
optionally applying a base layer of polymer resin to said support;
winding at least one layer of a filament material around said base layer or support to form a filament wound layer;
applying a layer of non-woven fibrous material over said filament wound layer to form an outer layer on said sleeve;
curing said sleeve; and
removing the cured sleeve from said support.

15. The method of claim 14 including impregnating said filament material with polymeric resin prior to winding said filament material around said base layer or support.

16. The method of claim 14 including applying an inner layer of non-woven fibrous material over said base layer or support prior to applying said layer of filament wound fibrous material and said outer layer of non-woven fibrous material.

17. The method of claim 14 wherein said filament wound layer comprises two or more wound filament layers which have been applied in succession.

18. The method of claim 14 wherein said filament material is wound at an angle of 80° to 90° from the centerline of said support.

19. The method of claim 14 wherein said filament material is wound at an angle of 30° to 60° from the centerline of said support.

20. The method of claim 14 wherein a portion of said filament material is wound at an angle of 80° to 90° from the centerline of said support and another portion is wound at an angle of 30° to 60° from the centerline of said support.

21. The method of claim 14 wherein said non-woven fibrous material comprises two plies.

22. The method of claim 14 wherein said non-woven fibrous material comprises four plies.

23. The method of claim 14 wherein said filament material comprises fiberglass.

24. The method of claim 14 wherein said non-woven fibrous layer comprises a fiberglass chopped strand mat.

25. An expandable hollow cylindrical thin-walled composite sleeve comprising at least one filament wound layer and at least one non-woven fibrous layer over said filament wound layer, said non-woven fibrous layer forming the outermost layer on said sleeve; wherein said at least one filament wound layer has been impregnated with a polymeric resin.

26. An expandable hollow cylindrical thin-walled composite sleeve comprising an inner non-woven fibrous layer, a filament wound layer over said non-woven fibrous layer, and an outer non-woven fibrous layer over said filament wound layer; wherein at least one of said layers has been impregnated with a polymeric resin.
